(19) United States
(12) Patent Application Publication
(10) Pub. No.: US 2006/0184984 A1
(43) Pub. Date: Aug. 17, 2006

(54) Method and system for intelligent indexing of recordable event identifiers

(75) Inventors: Mark D. Goodwin, Mountain View, CA (US); Richard Bullwinkle, Palo Alto, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Digital Networks North America, Inc., Santa Clara, CA (US)

(21) Appl. No.: 11/325,822

(22) Filed: Jan. 5, 2006

Related U.S. Application Data
(60) Provisional application No. 60/641,933, filed on Jan. 5, 2005.

(51) Int. Cl. H04N 7/173; H04N 7/16

(52) U.S. Cl. 725/89; 725/134; 725/142

(57) ABSTRACT

A method and a system for intelligent indexing of recordable event identifiers that improve user satisfaction in searching for recordable events or recorded events. Intelligent indexing of recordable event identifiers permits the indexing of recordable event identifiers based on the most likely methods that any of a plurality of users may use to enter data for performing a search for a recordable event or a recorded event. The intelligent indexing of recordable events allows any given user to use any of the most likely methods for entering data for use in searching for a recordable event or a recorded event, instead of being restricted to a single method for entering data to be used in performing a search for a recordable event or recorded event.

### RELATED APPLICATION

This application claims priority from U.S. Provisional Patent Application No. 60/641,933 filed Jan. 5, 2005. U.S. Provisional Patent Application No. 60/641,933, filed Jan. 5, 2005, is incorporated herein by reference in its entirety.

### FIELD OF THE INVENTION

The present invention relates to storing recordable event identifiers within a device and, more particularly, to performing intelligent indexing of recordable event identifiers for storage of recordable event identifiers within the device, for use in locating recordable events.

### BACKGROUND

Many devices include a data storage medium that allows a user of a given device to store user data within the given device. Storage of the user data may be for user convenience. The user convenience may result from a user not having to remember (or enter) the user data each time the device uses the user data in carrying out a given function. If accessing the user data is burdensome to the user, the user may forego using the function designed for user convenience, or in some cases, may lead to the user returning the device to the device's manufacturer (and/or to the seller of the device).

By way of example, the given device may be a wireless telephone. The user data stored in a data storage medium of the wireless telephone may include telephone numbers for people or business organizations that a user of the wireless telephone frequently calls. Each telephone number stored within the data storage medium may be stored with a corresponding nametag. For example, the user of the wireless telephone may store the telephone number “555-555-0001” and a first nametag “John Smythe” within the data storage medium of the wireless telephone by pressing keys on a keypad of the wireless telephone.

After storing the telephone number “555-555-0001”, the user may enter the first nametag into the device so as to recall the telephone number for use in placing a call to the telephone number. Entering a nametag into the telephone may occur by pressing keys on the wireless telephone keypad. If the user enters the first nametag “John Smythe,” the telephone can process the first nametag to recall the telephone number “555-555-0001.” However, if the user enters a second name tag “Smythe, John,” or enters a third name tag “John Smith,” the telephone will not be able to recall the telephone number “555-555-0001” associated with the first nametag. This is an inconvenience to the user of the wireless telephone.

As another example, recordable event recording devices, such as a digital video recorder (DVR), may include data storage for storing recordable event data that pertains to recordable events that have been previously recorded or may be scheduled for recordation at some time in the future. DVRs include a user interface that facilitates searching for and identification of a recordable event. Unfortunately, up to this point in time, DVRs require a user to enter recordable event data for use in searching for and identifying a recordable event in a single pre-defined form. If the user enters recordable event data in some form other than the single pre-defined form, the DVR cannot locate the recordable event. This can lead to a user of the DVR becoming frustrated and potentially returning the DVR to the DVR manufacturer (or to the DVR seller).

### SUMMARY

An exemplary embodiment of a method and system for intelligent indexing of recordable event identifiers is described. Intelligent indexing of recordable event identifiers allows for identifying data for a given recordable event by entering at least a portion of any of a plurality of forms of a recordable event identifier for the given recordable event. Thus, a user employing the method or system for intelligent indexing of recordable event identifiers to identify data for the given recordable event is not restricted to entering only a single form of a recordable event identifier in order to identify data for the given recordable event.

A recordable event is any type of event that may be recorded by a recordable event recording device, such as a digital video recorder. Examples of recordable events include (i) a television show, such as a television show broadcasted by a television station or downloaded/streamed via the Internet, and (ii) a radio program, such as a radio program broadcasted by the transmission of radio frequency signals or by streaming the radio program over a network, such as the Internet.

Each recordable event may be characterized by one or more recordable event identifiers. Each recordable event identifier may exist in one or more forms. The one or more forms of a recordable event identifier may be sent to a recordable event recorder prior to transmission of the recordable event so that the recordable event recorder may schedule to record the recordable event identified by the recordable event identifier.

The one or more forms of a recordable event identifier may be arranged in any of a variety of configurations. A first form of a recordable event identifier based on an Actor's name (for example, Arnold Schwarzenegger) may be arranged as the Actor's family name (Schwarzenegger) followed by the Actor's given name (Arnold). A second form of the recordable event identifier based on the Actor's name (Arnold Schwarzenegger) may be arranged as the Actor's given name (Arnold) followed by the Actor's family name (Schwarzenegger). Other examples of the forms of a recordable event identifier are also possible.

According to the exemplary embodiment, the system for intelligent indexing of recordable event identifiers may be arranged as a system that includes (i) a communication interface, (ii) a processor for executing a set of program instructions, (iii) data storage for storing the set of program instructions and for storing a recordable event identifier index, and (iv) a user interface for receiving at least a portion of a user-entered recordable event identifier.

In one respect, the communication interface of the system may be arranged to receive a first form of a recordable event identifier. In this regard, the set of program instructions executable by the processor includes instructions for analyzing the first form of the recordable event identifier to determine that at least a second form of the recordable event identifier is desirable and to responsively produce the at least a second form of the recordable event identifier.

In another respect, the communication interface of the system may be arranged to receive a recordable event identifier index that includes a plurality of forms of a recordable event identifier for one or more recordable event identifiers. In this regard, the data storage stores the received recordable event identifier index.

Further, the set of program instructions may include instructions for analyzing the at least a portion of a user-entered recordable event identifier so as to be able identify one of the plurality of forms of a recordable event identifier for a given recordable event. After identification of the recordable event identifier, the system may schedule the given recordable event for recordation.

According to the exemplary embodiment, the method for indexing a recordable event identifier involves: (i) storing a first form of a recordable event identifier into a first portion of a recordable event identifier index, (ii) storing a second form of the recordable event identifier into a second portion of the recordable event identifier index, and (iii) receiving a user-entered recordable event identifier to be used in searching for the recordable event identifier index to locate the first form of the recordable event identifier or the second form of the recordable event identifier.

In one respect, the method may involve (i) receiving a recordable event identifier index that includes at least a first form of a recordable event identifier and a second form of the recordable event identifier for a given recordable event, and (ii) storing the recordable event identifier index in a data storage medium.

In another respect, the method may involve (i) receiving the first form of the recordable event identifier, (ii) analyzing the first form of the recordable event identifier so as to produce a second form of the recordable event identifier, and (iii) storing the first form of the recordable event identifier and the second form of the recordable event identifier in a recordable event identifier index at the data storage medium.

These and other aspects, advantages, and alternatives will become more apparent to those of ordinary skill in the art by reading the following detailed description, with reference where appropriate to the accompanying drawings.

### BRIEF DESCRIPTION OF THE DRAWINGS

Exemplary embodiments of the present invention are described herein with reference to the drawings, in which:

FIG. 1 illustrates a first portion of a recordable event identifier index used for intelligent indexing of recordable event identifiers;

FIG. 2 illustrates a second portion of a recordable event identifier index used for intelligent indexing of recordable event identifiers;

FIG. 3 is a block diagram illustrating an exemplary embodiment of a system for carrying out the present invention;

FIG. 4 illustrates a third portion and a fourth portion of a recordable event identifier index used for intelligent indexing of recordable event identifiers;

FIG. 5 illustrates another portion of a recordable event identifier index used for intelligent indexing of recordable event identifiers;

FIG. 6 is a flow chart depicting functions that can be carried out in accordance with an exemplary embodiment of the present invention

FIG. 7 depicts an example of a graphical user interface (GUI) displaying the results of a first show search by show title;

FIG. 8 depicts an example of a GUI displaying the results of a second show search by show title;

FIG. 9 depicts an example of a GUI displaying the results of a show search by actor's last name;

FIG. 10 depicts an example of a GUI displaying the results of a show search by actor's first name; and

FIG. 11 depicts an example of a GUI displaying the results of performing a Surprise

### DETAILED DESCRIPTION OF AN EXEMPLARY EMBODIMENT

### 1. OVERVIEW

An exemplary embodiment of a method and system for intelligent indexing of recordable event identifiers is described herein. Intelligent indexing of recordable event identifiers allows for identifying data for a given recordable event after receiving at least a portion of any of a plurality of forms of a user-entered recordable event identifier for the given recordable event. Identifying data for a given recordable event allows for the data for the given recordable event identifier to be presented to a user and/or allows for scheduling the given recordable event for recordation.

A recordable event is any type of event that may be recorded by a recordable event recording device, such as a digital video recorder (DVR). An example of a DVR is the DVR having model number “ReplayTV 5532”, which is sold by ReplayTV®, a Digital Networks North America Company. Other examples of DVRs, such as those sold by ReplayTV®, are also possible.

An example of a recordable event is a television show, such as the television show entitled “Friends” that originally aired on the National Broadcasting Company (NBC) network. Another example of a recordable event is a radio show, such as the Howard Stem radio show that is broadcast by the radio station WXRK at 92.3 MHz from New York, N.Y. Yet another example of a recordable event is an event that is delivered via the Internet or another wired/wireless network. In this regard, delivery via the Internet may occur by downloading or streaming a recordable event to a device that records the event. Other examples of recordable events are also possible.

Each recordable event may be characterized by one or more recordable event identifiers. By way of example, a recordable event of the television show “Friends” that is to be broadcast by a given affiliate of the NBC network at 8:00 PM to 8:30 PM on a given Wednesday, where the given affiliate has the call letters WMAQ-TV and a channel number of 5 may have one or more recordable event identifiers. In this regard, this recordable event may have the following recordable event identifiers: (i) show title “Friends”, (ii) time slot “8:00 PM to 8:30 PM,” (iii) day of the week “Wednesday”, (iv) call letters “WMAQ-TV”, and (v) channel number “5”. Other examples of recordable event identifiers other than show title, time slot, day of the week, call letters, or channel number, for a given recordable event are also possible.

Each recordable event identifier available for use in a recordable event recorder may exist in one or more forms. Further, a recordable event recorder may receive the one or more forms of a recordable event identifier in various ways. In one respect, a first form of a recordable event identifier may be sent to a recordable event recorder and the recordable event recorder may function to produce additional recordable event identifiers based on the first form of the recordable event identifier. Thereafter, the first form of the recordable event identifier and the additional recordable event identifiers may be stored in a recordable event identifier index.

In another respect, more than one form of a recordable event identifier may be sent to a recordable event recorder. The one or more forms of a recordable event identifier may be stored in a recordable event identifier index.

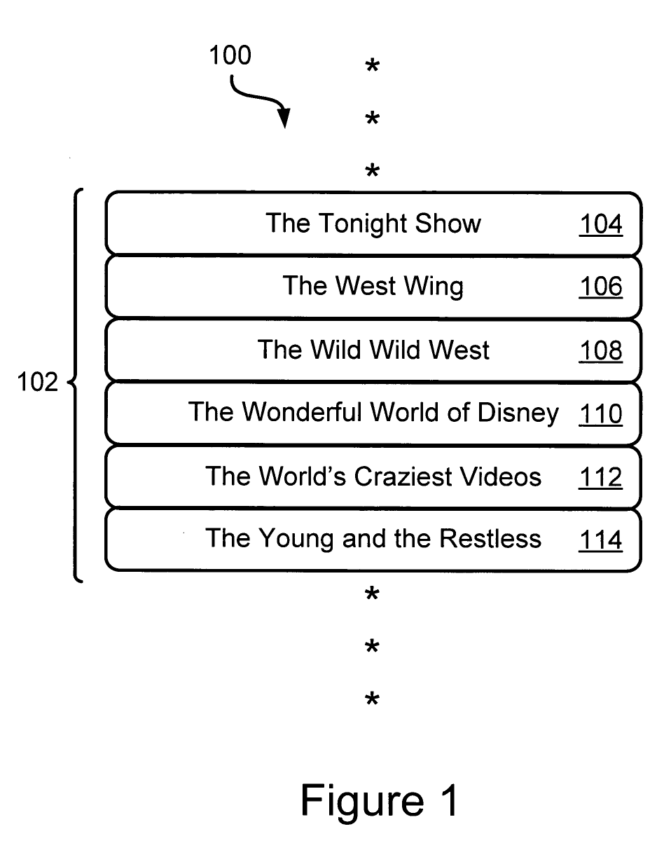

FIG. 1 illustrates an example of a first portion 102 of a recordable event identifier index 100 that includes a first plurality of recordable event identifiers, each based on a respective television show title. In particular, the first plurality of recordable event identifiers include (i) a first identifier 104 labeled “The Tonight Show,” (ii) a second identifier 106 labeled “The West Wing,” (iii) a third identifier 108 labeled “The Wild Wild West,” (iv) a fourth identifier 110 labeled entitled “The Wonderful World of Disney,” (v) a fifth identifier 112 labeled “The World's Craziest Videos,” and (vi) a sixth identifier 114 labeled “The Young and the Restless.” Each of the identifiers 104, 106, 108, 110, 112, 114 may be associated with other respective recordable event identifiers that identify data such as show title data, time slot data, day(s) of the week data, call letter data, channel number data, actors' names, and director's name.

The plurality of recordable event identifiers 104, 106, 108, 110, 112, 114 are in alphabetical order. The symbols “* * *” above the first identifier 104 indicate that additional recordable event identifiers may exist above the first identifier 104. The symbols “* * *” below the sixth identifier 114 indicate that additional recordable event identifiers may exist below the sixth identifier 114.

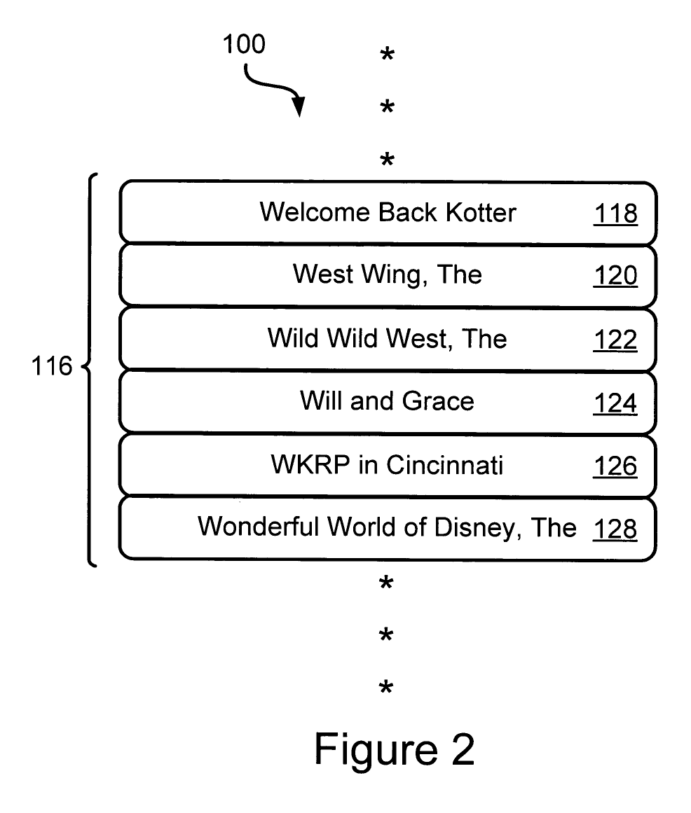

FIG. 2 illustrates an example of a second portion 116 of the recordable event identifier index 100 that includes a second plurality of recordable event identifiers, each based on a respective television show title. In particular, the second plurality of recordable event identifiers include (i) a seventh identifier 118 labeled “Welcome Back Kotter,” (ii) an eighth identifier 120 labeled “West Wing, The,” (iii) a ninth identifier 122 labeled “Wild Wild West, The,” (iv) a tenth identifier 124 labeled “Will and Grace,” (v) an eleventh identifier 126 labeled “WKRP in Cincinnati,” and (vi) a twelfth identifier 128 labeled “Wonderful World of Disney, The.” Each of the identifiers 116, 118, 120, 122, 124, 126, 128 may be associated with other respective recordable event identifiers that identify data such as show title data, time slot data, day(s) of the week data, call letter data, and channel number data.

The plurality of recordable event identifiers 116, 118, 120, 122, 124, 126, 128 are in alphabetical order. The symbols “* * *” above the seventh identifier 116 indicate that additional recordable event identifiers may exist above the seventh identifier 116. The symbols “* * *” below the twelfth identifier 128 indicate that additional recordable event identifiers may exist below the twelfth identifier 128.

The intelligent indexing of recordable events in the recordable event identifier index 100 may be observed by comparing the first portion 102 shown in FIG. 1 to the second portion 116 shown in FIG. 2. In particular, the second identifier 106 is a first form of a recordable event identifier based on a recordable event title for a recordable event entitled “The West Wing.” The eighth identifier 120 is a second form of the recordable event identifier based on the recordable event title for the recordable event entitled “The West Wing.”

Further in particular, the third identifier 108 is a first form of a recordable event identifier based on a recordable event title for a recordable event entitled “The Wild Wild West.” The ninth identifier 122 is a second form of the recordable event identifier based on the recordable event title for the recordable event entitled “The Wild Wild West.”

Further still in particular, the fourth identifier 110 is a first form of a recordable event identifier based on a recordable event title for a recordable event entitled “The Wonderful World of Disney.” The twelfth identifier 128 is a second form of the recordable event identifier based on the recordable event title for the recordable event entitled “The Wonderful World of Disney.”

The intelligent indexing of recordable events in the recordable event identifier index 100 allows a user to identify data for a given recordable event by entering any of a plurality of recordable event identifiers for the given recordable event. For example, a user may input a first user-entered identifier “West Wing” or a second user-identifier “The West Wing”, so as to be able to identify data for the television show entitled “The West Wing.” As another example, a user may search for the recordable event “The Wild Wild West” by entering the third identifier 108 and/or the ninth identifier 122. As yet another example, a user may search for the recordable event “The Wonderful World of Disney” by entering the fourth identifier 110 and/or the twelfth identifier 128. Thus, a user is not restricted to any single form of a user-entered identifier so as to be able to identify data for a recordable event when it is desirable to have more than one form of recordable event identifier for a given recordable event identifier of a given recordable event.

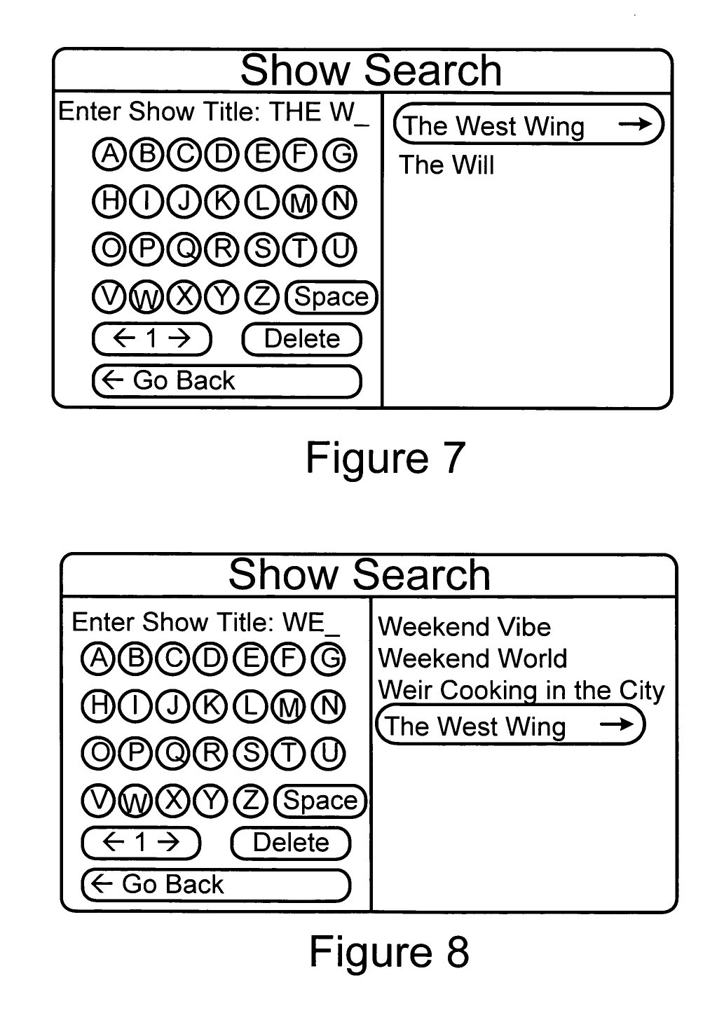

These examples show how a user may interpret the name of a recordable event in more than one way. It is very common for a user to think of the television show “The West Wing” as “The West Wing” or “West Wing.” As an example, FIG. 7 depicts a graphical user interface (GUI) that displays the results of a show search by show title where a user has entered the letters “THE W.” In this regard, the rules have been arranged so that shows having titles that begin with the letters “THE W” are displayed on the right side of the GUI. If the user then enters the letter “E”, the search results will show a single show entitled “The West Wing.”

Advantageously, a user does not have to (i) enter all letters (or numbers) of a given identifier, nor (ii) enter a sufficient number of letters to eliminate all identifiers but the given identifier, in order to select the select the given identifier. For instance, once a user enters the letters “THE W”, as shown in FIG. 7, the user can switch a selection means to the right side of the GUI and move the selection means up or down the GUI display to select one of the displayed show titles. In particular, the user could select the show having the title “The West Wing” from right side of the GUI without entering all letters of the show title “The West Wing.”

As another example, FIG. 8 depicts a GUI that displays the results of a show search by show title where a user has entered the letters “WE.” In this regard, the rules have been arranged so that shows having titles that begin with the letters “WE” are displayed on the right side of the GUI. If the user then enters the letter “S”, the search results will show a single show entitled “The West Wing.” FIGS. 7 and 8 illustrate that the rules may be defined for user convenience so that a user may search for a recordable event by using terms that are most convenient and/or memorable to the user.

The rules that allow a user to search for a recordable event with or without the prefix “The,” may also be arranged for other prefixes, such as “A”, “An”, and “It's a.” In this regard, the rules would allow a user to search for the movie entitled “Its a Wonderful Life” by entering the term “Its a Wonderful Life,” or “A Wonderful Life, Its,” or “Wonderful Life, Its a.”

Further, these rules may be defined for more complex prefixes. For example, rules may be defined to allow a user to search for a recordable event known as “Star Trek: Enterprise” by the term “Star Trek: Enterprise,” or just by the term “Enterprise,” which is a term commonly used in reference to the recordable event “Star Trek: Enterprise.” As another example, rules may be defined to allow a user to search for a recordable event entitled “The Adventures of Jimmy Neutron” as “The Adventures of Jimmy Neutron,” or “Jimmy Neutron, The Adventures of,” or by some other term. These examples show how a system can allow a user to search for recordable events by entering a complete identifier of the recordable event and by entering an abbreviated identifier of the recordable event. Other examples of how these rules may be defined are also possible.

### 2. EXEMPLARY ARCHITECTURE

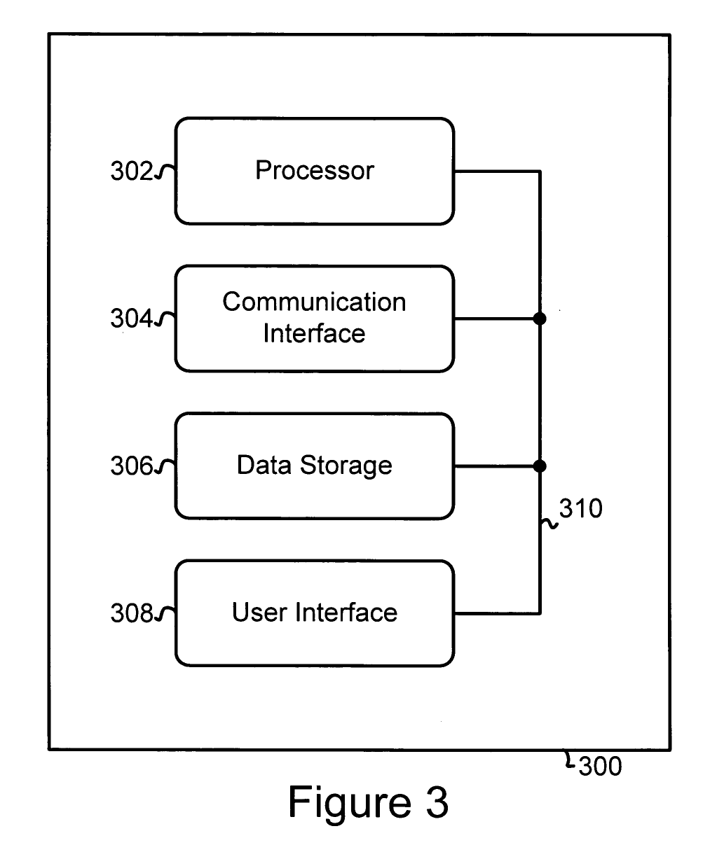

The block diagram of FIG. 3 depicts a system for use in intelligently indexing a recordable event identifier of a recordable event. As shown in FIG. 3, the system 300 includes (i) a processor 302, (ii) a communication interface 304, (iii) data storage 306, and (iv) a user interface 308, all linked together via a system bus, network, or other connection mechanism 310.

The processor 302 may include one or more processors, such as one or more general purpose processors and/or one or more digital signal processors. The processor 302 executes program instructions that are stored at the data storage 306, and responsively functions to interact with the communication interface 304 and the user interface 308, to facilitate performance of the functions described herein.

The communication interface 304 facilitates the reception of data into the system 300 from a first remote device or system. The first remote device or system may include a remote server operating at an entity that transmits various forms of data into the system 300. An example of the entity that transmits data into the system 300 is Replay TV®.

A first type of data that the system 300 may receive is a recordable event. As an example, the communication interface 304 may receive into the system 300 a recordable event transmitted from a remote device or system operated by a cable television supplier. Receiving a recordable event may occur at a predefined time, such as a time pre-defined in a set of recordable events data. Alternatively, receiving a recordable event may occur at a user-selected time. In this regard, the user-selected time may be a time the user has selected to receive an on-demand pay-per-view movie that can start at a time specified by the user.

A second type of data that the system 300 may receive is a set of recordable events data. The set of recordable events data may include (i) data for determining a recordable event identifier index, and/or (ii) a recordable event identifier index, and/or (iii) a first form of a recordable event identifier for a given type of recordable event identifier for a given recordable event. The recordable events data may include recordable event identifiers for a plurality of recordable events. Other examples of data that may be received into the system 300 are also possible.

The communication interface 304 also facilitates the transmission of data from the system 300 to a remote device or system, such as the first remote device or system. The communication interface may transmit a variety of data to the remote device or system. For example, the communication device may transmit (i) a request to update a set of recordable events data, and/or (ii) a request to receive a recordable event, and/or (iii) a request for the remote device or system to transmit a recordable event identifier index. Other examples of data that the communication interface 304 may transmit to a remote device or system are also possible.

The communication interface 304 may be arranged in various configurations to transmit and/or receive data. For example, the communication interface 304 may be arranged as a wireless interface that receives data encoded within radio-frequency signals broadcast by a terrestrial antenna and/or a satellite circumnavigating the Earth. As another example, the communication interface 304 may be arranged as a wired interface that receives data encoded within signals transmitted via a traditional copper telephone land-line, or a coaxial cable, such as a cable for routing cable television signals, or a data network cable, such as a category 5 cable or an optical cable. The communication interface 304 may interface to a private network, such as a local area network, or a public-access network, such as the Internet. Other examples of the arrangements for the communication interface 304 are also possible.

The communication interface 304 may include means for converting a received recordable event into a format that may be stored in data storage 306. In this regard, the means for converting a received recordable event may include a signal conditioning means, and/or a signal conversion means (such as conversion from an analog signal to a digital signal), and/or a signal filtering means, so as to convert a recordable event into a format that may be stored in the data storage 306.

The data storage 306 may include a computer readable and writeable medium, such as a magnetic disc, an optical disc, organic memory, and/or any other volatile and/or non-volatile mass storage system readable and writable by the processor 302. Alternatively, the data storage 306 includes a combination of one or more segments of computer readable and writable media. In this regard, for example, data storage 306 may include a first segment of computer readable and writable media located in the processor 302 and a second segment of computer readable and writable media remote from the processor 302. As an example, the second segment of computer readable and writable media may be arranged as (i) a portable hard-drive data storage unit, or (ii) an integral hard-drive storage unit, or (iii) a magnetic tape, such as a VHS-format video tape. Other examples of data storage 306 or segments of the data storage 306 are also possible.

The data storage 306 may store various types of data. For example, the data storage 306 may store program instructions executable by the processor 302 in non-volatile data storage. In particular, the program instructions may include instructions that are executable to analyze a set of recordable events data (for example all data for all recordable events to be broadcast by a local cable television supplier) for determining one or more recordable event identifiers for each respective recordable event among the plurality of recordable events.

Further, in particular, the program instructions may include instructions that are executable to analyze the recordable events identifier data to determine whether it would be desirable to have additional forms of a given recordable event identifier. In this regard, the program instructions may include instructions for producing the additional forms of the given recordable event identifier in response to making the determination that it would be desirable to have the additional forms.

Further still, the program instructions may include instructions that are executable to store recordable event identifiers in a recordable event identifier index. In this regard the program instructions may include instructions for storing a recordable event identifier index received from a remote device, and/or instructions for storing a recordable event identifier index produced by executing program instructions within the processor 302, where the recordable event identifier index is based on the recordable events identifier data received from a remote device and/or from the user interface 308. Other examples of the program instructions executable by the processor 302 are also possible.

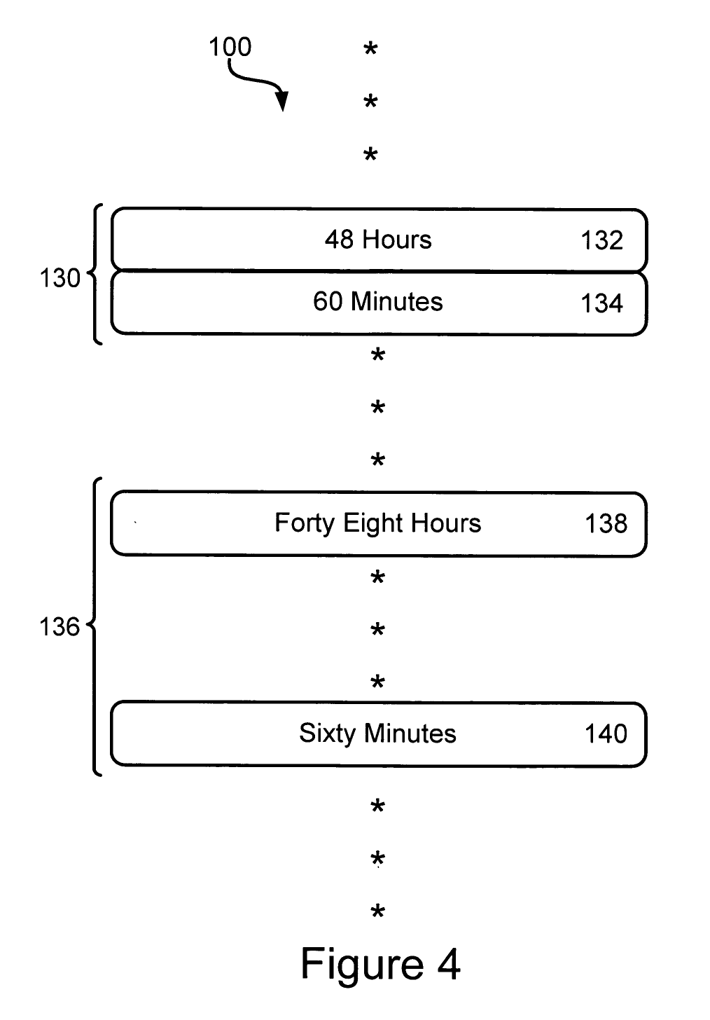

As another example, the data storage 306 may store a recordable event identifier index, such as the recordable event identifier index 100 that includes the first portion 102 shown in FIG. 1 and the second portion 116 shown in FIG. 2. The recordable event identifier index 100 may include other portions of the index as well. For example, as shown in FIG. 4, the recordable event identifier index 100 may include a third portion 130 that includes recordable events identifiers having labels with numbers in the show title. For instance, the third portion 130 may include a thirteenth identifier 132 labeled “48 Hours” and a fourteenth identifier 134 labeled “60 Minutes.”

As another example, the recordable event identifier index 100 may include a fourth portion 136 that includes a fifteenth identifier 138 labeled “Forty Eight Hours” and a sixteenth identifier 140 labeled “Sixty Minutes.” In this regard, the thirteenth identifier 132 is associated with the fifteenth identifier 138, in that both of these identifiers are identifiers for a recordable event in the form of a television show having the title “48 Hours.” Further, the fourteenth identifier 134 is associated with the sixteenth identifier 140, in that both of these identifiers are identifiers for a recordable event in the form of a television show having the title “60 Minutes.”

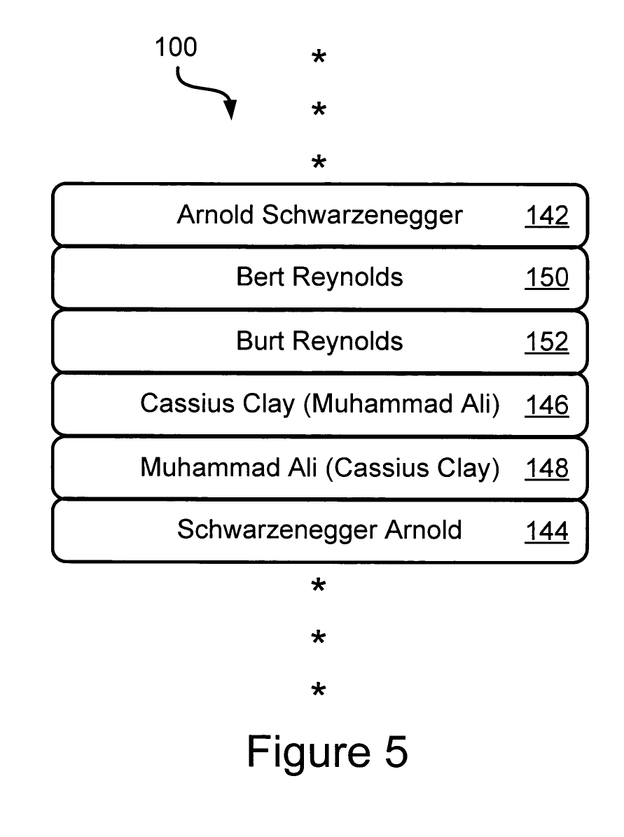

As yet another example, the recordable event identifier index 100 may include a plurality of recordable event identifiers to compensate for the various orders in which a person's name may be entered. In this regard, for example, the person's name could be an actor's name, a director's name, a producer's name, a musical recording artist's name, or some other name associated with a recordable event. For example, as shown in FIG. 5, the recordable event identifier index 100 may include a seventeenth recordable event identifier 142 that is in the form of a given name (for example, “Arnold”) followed by a family name (for example, “Schwarzenegger”), and an eighteenth recordable event identifier 144 that is in the form of a family name (for example, “Schwarzenegger”) followed by a given name (for example, “Arnold”). Accordingly, a user could search for recordable events that are associated with the actor named Arnold Schwarzenegger by use of the seventeenth recordable event identifier 142 and/or the eighteenth recordable event identifier 144.

As still yet another example, the recordable event identifier index 100 may include recordable event identifiers to compensate for changes associated with the data within a recordable event identifier. As an example, a user may desire to search for recordable events that pertain to the boxing champion Muhammad Ali. Muhammad Ali changed his name from Cassius Clay to Muhammad Ali after having boxed under the name of Cassius Clay. With an intelligent indexing for recordable event identifiers, the recordable event identifier index 100 may include a nineteenth recordable event identifier 146 labeled “Cassius Clay (Muhammad Ali)” that is associated with a twentieth recordable event identifier 148 labeled “Muhammad Ali (Cassius Clay).” In this way, if the user-entered recordable event identifier is either “Muhammad Ali” or “Cassius Clay,” the system 300 will present the recordable events that are associated with “Muhammad Ali” and/or “Cassius Clay.” Other examples of the recordable event identifier index having recordable event identifiers to compensate for changes to data of a recordable event are also possible.

The nineteenth recordable event identifier 146 and the twentieth recordable event identifier 148 each include two names (i.e., a particular person's original name and the particular person's name after changing it). The two names may be included for various reasons such as to (i) improve a user's experience with the system 300, and/or (ii) reassure a user that the user has made a correct selection so as to be able to locate recordable events the user is trying to locate. Alternatively, more than two names could be included in a recordable event identifier. If the amount of space for displaying names will not allow the full names to be displayed, abbreviations (e.g., M. Ali (C. Clay)) could be used to display names of a recordable event identifier.

And, as still yet another example, the recordable event identifier index 100 may include recordable event identifiers to compensate for misspelled words of a user-entered recordable event identifier. As an example, a user may desire to search for recordable events that include the actor having the name “Burt Reynolds.” However, when entering the user-entered recordable event identifier, the user may mistakenly enter the user-entered recordable event identifier labeled “Bert Reynolds.” With an intelligent indexing for recordable event identifiers, the recordable event identifier index 100 may include a twenty-first recordable event identifier 150 labeled “Bert Reynolds” that is associated with a twenty-second recordable event identifier 152 labeled “Burt Reynolds.” Accordingly, a user could search for recordable events that are associated with the actor named Burt Reynolds by use of the twenty-first recordable event identifier 150 and/or the twenty-second recordable event identifier 152. Other examples of misspelled words of a user-entered recordable event identifier, such as a misspelled show title, are also possible.

The data storage 306 may also store a schedule of the recordable events that are to be recorded based on the recordable events selected by a user. Further, the data storage 306 may store one or more recordable events based on the schedule of the recordable events. Other examples of the data stored in the data storage 306 are also possible.

The user interface 308 provides means for a user to communicate data into the system. As an example, the means for a user to communicate data into the system may include (i) a wireless remote control receiver for receiving wireless communication from a remote control, and/or (ii) a keypad or touch-screen for receiving data input by a user pressing keys correlated with certain data and or functions, and/or (iii) a speech recognition system for receiving data and or commands spoken by a user. Other examples of the means for a user communicating data into the system are also possible.

Various types of data may be communicated into the system 300 via the user interface 308. As an example, the data communicated into the system 300 may include a user request for the system 300 to request an update of a set of recordable events data (including recordable event identifiers). As another example, the data communicated into the system 300 via the user interface may include a user-entered recordable event identifier or a portion of a user-enterer recordable event identifier. Other examples of the types of data that may be communicated into the system 300 are also possible.

As another example, a user may communicate into the system 300, a signal that indicates to perform a “Surprise Me” feature. The Surprise Me feature provides a means for a user of the system 300 to schedule shows to be recorded based on a predetermined search criteria and a set of rules based on the predetermined search criteria. The Surprise Me feature allows for recording recordable events based on the predetermined search criteria and the set of rules so long as no other recordable events are scheduled to be recorded. The Surprise Me feature may include a time limit, such as 4 hours, so that only 4 hours of shows based on the predetermined search criteria and the set of rules are recorded.

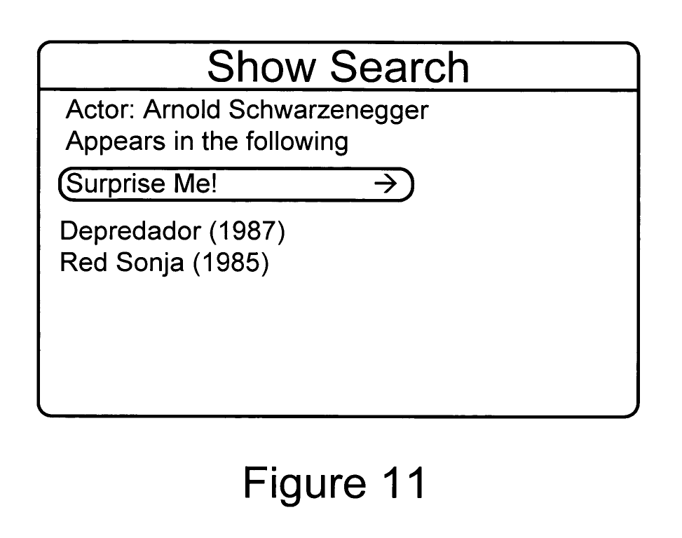

For instance, the predetermined search criteria and the set of rules may be defined such that movies that include the actor Arnold Schwarzenegger are to be recorded. As shown in FIG. 11, use of the Surprise Me, based on the predefined search criteria and the set of rules, two movies (Depredador and Red Sonja) may be scheduled for recordation. Alternatively, the two movies shown in FIG. 11 may already have been recorded.

The user interface 308 also provides means for communicating data to a user of the system 300. In this regard, the data communicated to the user may be data that is (i) visual on a display, such as a touch screen, a liquid crystal display, a cathode ray tube, or a plasma screen, or (ii) audible via a speaker. Other examples of the user interface 308 providing means for communicating data to the user of the system 300 are also possible.

Various types of data may be communicated to a user from the system 300. For example, the user interface 308 may display a user-entered recordable event identifiers as the user-entered recordable event identifier is being input via the user interface 308. As another example, the user interface may display the results of a search for recorded events or recordable events based on the user-entered recordable event identifier. Other examples of data that may be communicated to the user from the system 300 are also possible.

FIG. 3 provides an overview of a system for carrying out the system and method for intelligent indexing of recordable event identifiers. It should be understood, however, that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether. Further, many of the elements described herein are functional entities that may be implemented as discrete or distributed components or in conjunction with other components, in any suitable combination and location.

### 3. EXEMPLARY OPERATION

According to the exemplary embodiment, the system 300 receives recordable event identifier data. The recordable event identifier data may include a plurality of recordable event identifiers each arranged as a respective form of a recordable event identifier for particular recordable event data, such as an actor's name. Alternatively, the system 300 may produce additional forms of recordable event identifiers for the particular recordable event data for which it is desirable to have the additional forms of the recordable event identifiers.

Further, the system 300 stores the plurality of recordable event identifiers and provides for locating one of a plurality of recordable event identifiers for a given recordable event in response to receiving at least a portion of a user-entered recordable event identifier that is associated with the particular recordable event data.

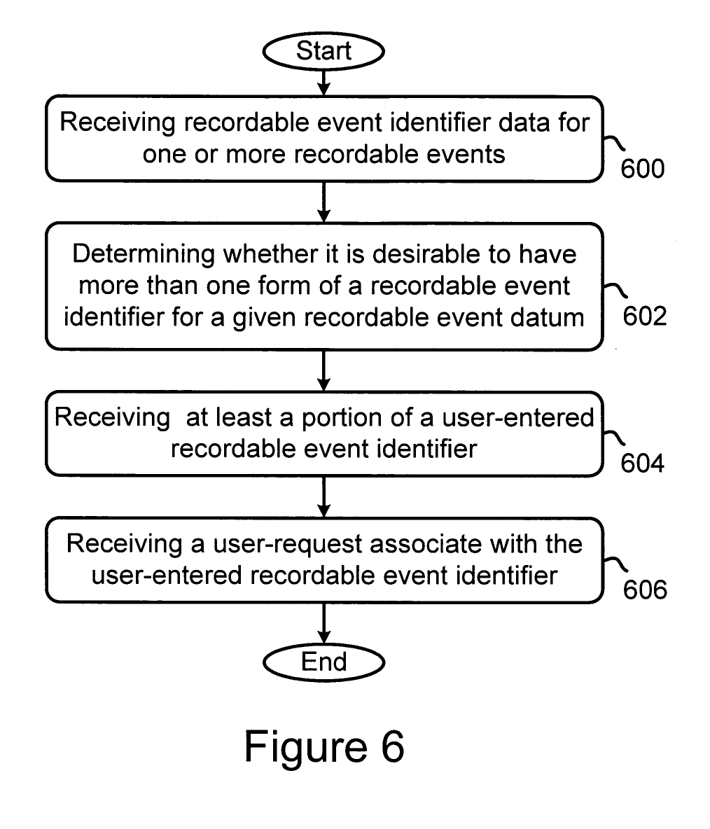

FIG. 6 is a flow chart provided to illustrate some of these functions. As shown in FIG. 6, at block 600, recordable event identifier data for one or more recordable events is received at a local device. The local device may include the communication interface 308 as described above.

Various arrangements of recordable event identifier data may be received at the local device. For example, the recordable event identifier data may be arranged as electronic programming guide data. In this regard, the electronic programming guide data may include data for all recordable events to be presented via a given medium over a given period of time. For example, the recordable event identifier data may include data pertaining to all television shows that are to be presented by a cable television supplier over a 14 day period. Other examples, where the given medium is a medium other than television shows presented by a cable television supplier and where the given period of time is other than 14 days, are also possible.

At block 602, a determination is made as to whether it is desirable to have more than one form of a recordable event identifier for a given bit of recordable event identifier data. The determination could be made at a remote device, where the remote device is part of a system that facilitates sending the recordable event identifier data to the local device. The determination may be based on research results that indicate how users may enter data when searching for a recordable event.

If the determination made at the remote device is that it is desirable to have more than one form of a recordable event identifier for the given bit of recordable event identifier data, then the remote device may function to produce the additional forms of the recordable event identifier. In this regard, the remote device may produce a recordable event identifier index for sending to the local device, where the recordable event identifier index includes a plurality of recordable event identifiers for the given bit of recordable event identifier data.

If the determination made at the remote device is that it is not desirable to have more than one form of a recordable event identifier for the given bit of recordable event identifier data, then the remote device need only send one form of the recordable event identifier to the local device. The one form of the recordable event identifier may be part of a recordable event identifier index that is sent to the local device and then stored at the local device, or is stored as part of a recordable event identifier index that the local device produces and stores within a data storage medium of the local device.

Alternatively, or in combination, the determination may be made at the local device. In this regard, the local device may include a processor for executing program instructions for analyzing the received recordable event identifier data so as to determine whether it is desirable to have more than one form of a recordable event identifier for the given bit of recordable event identifier data.

If the determination made at the local device is that it is desirable to have more than one form of a recordable event identifier for the given bit of recordable event identifier data, then the processor at the local device executes program instructions for producing the additional forms of the recordable event identifiers. Thereafter, the plurality of forms of recordable event identifiers may be stored in a recordable event identifier index located in a data storage medium.

If the determination made at the local device is that it is not desirable to have more than one form of a recordable event identifier for the given bit of recordable event identifier data, then the local device need only store the one form of the recordable event identifier that was received from the remote device. The one form of the recordable event identifier may be stored in the recordable event identifier index, along with a plurality of other recordable event identifiers associated with other recordable event data.

At block 604, at least a portion of a user-entered recordable event identifier is received at the local device. A user interface, such as the user interface 308 shown in FIG. 3, may provide a means for a user to enter the user-entered recordable event identifier and the means for receiving the user-entered recordable event identifier. As the user-entered recordable event identifier in being entered, the system may begin searching the recordable event identifier index for the portion of the user-entered recordable event identifier that has been entered.

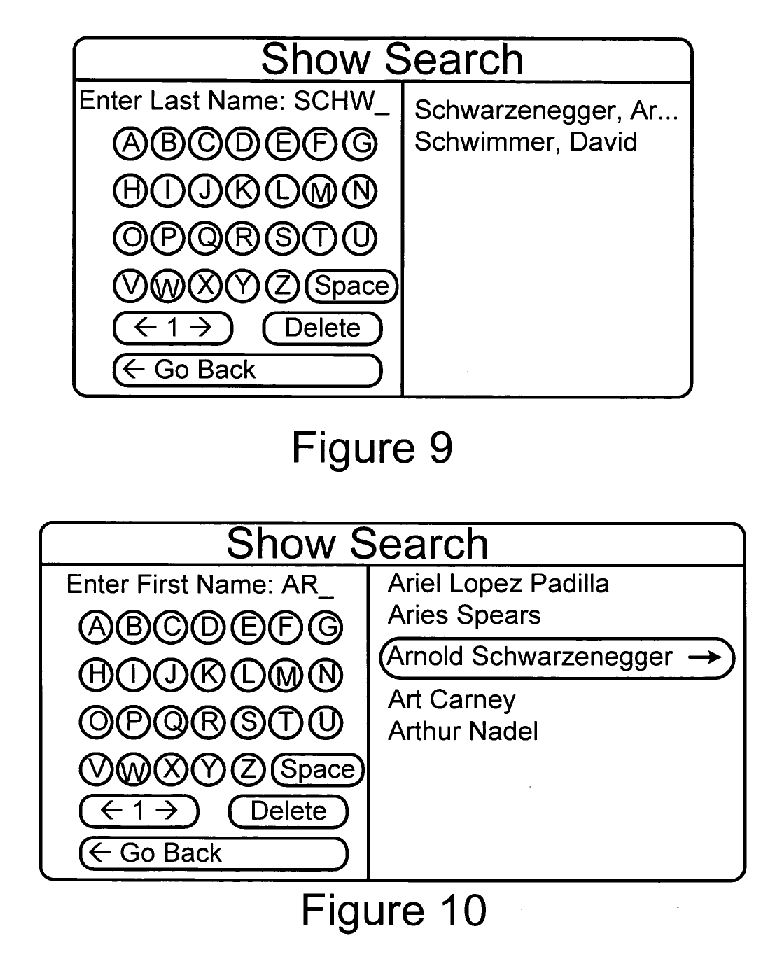

In one respect, only a portion of a user-entered recordable event identifier may have to be entered because the system may detect that the portion of the user-entered recordable event identifier is unique and is associated with only one recordable event identifier. For example, a user may enter the letters “SCHW” and the system will detect that this portion of the user-entered recordable event identifier is associated with the eighteenth recordable event identifier 144 (Schwarzenegger Arnold). FIG. 9 depicts a GUI arranged according to the exemplary embodiment. In FIG. 9, the left side of the GUI displays a means for entering letters of an actor's name and that the letters “SCHW” have been entered. The right hand side of the GUI displays the names of two actors having last names that start with the letters “SCHW.” According to the exemplary embodiment, a user could select the one of the two actors names from the right side of the GUI, and/or the user could enter another letter, such as the letter “A” to narrow the search down to a single actor. In this case, the actor named Schwarzenegger, Ar . . . .

FIG. 10 depicts a GUI that displays a user performing a show search by entering letters of an actor's first name. In this case, the user has entered the letters “AR” and the system has identified five actors whose names start with the letters “AR.” Again a user may enter additional letters to reduce the number of actors that are displayed for the given search criteria, in this case letters of an actor's first name.

In another respect, an entire user-entered recordable event identifier may have to be entered for the system to detect a unique recordable event identifier. For example, the recordable event identifier index may include a recordable event identifier labeled “John Smith” but the user wants to enter the user-entered recordable event identifier labeled “John Smithe.” In this regard, the system may respond by (i) detecting that “John Smith” is a unique recordable event identifier as a portion of “John Smithe” is entered and responsively provides the “John Smith” recordable event identifier as a short-cut to entering the entire recordable event identifier, and (ii) allow the user to enter the complete recordable event identifier “John Smithe” so that a unique recordable event identifier that is not in the recordable event identifier index can be entered. Entering a recordable event identifier that is not in the recordable event identifier index allows for scheduling to record recordable events associated with the recordable event identifier that is not in the recordable event identifier index.

After entering at least a portion of a user-entered recordable event identifier, next at block 606, a user-request associated with the user-entered recordable event identifier is received. A user interface, such as the user interface 308 shown in FIG. 3, may provide a means for a user to enter the user-request.

A variety of user-requests may be received. For example, a first user-request may be to select one of a plurality of recordable event identifiers detected in response to entering a portion of the user-entered recordable event identifier. Selecting one of the plurality of recordable event identifiers can save the user time by not having to enter the entire user-entered recordable event identifier.

As another example, a second user-request may be to select a previously recorded event from among one or more previously recorded events associated with the user-entered recordable event identifier. Selecting the previously recorded event allows for processing the recordable event. Examples of processing the recordable event include (i) sending the recordable event to a playback device, such as a television, and (ii) sending the recordable event to a remote recording device, such as a video cassette recording, for storing the recordable event on a second data storage medium. Other examples of processing the previously recorded event are also possible.

As yet another example, a third user-request may be to schedule the recordation of recordable events associated with the user-entered recordable event identifier. In particular, scheduling the recordation may include scheduling all recordable events associated with the user-entered recordable event identifier or a portion of all recordable events associated with the user-entered recordable event identifier.

Scheduling the portion of all recordable via the third user-request may involve selecting the portion of all recordable events based on a particular series of recordable events. Examples of series of recordable events that may be selected include (i) all recordable events broadcast on a given channel, at a given time, on a given day of the week, over a given period of time, (ii) a specific genre (for example comedic or science fiction) of recordable events for a given actor, (iii) a specific genre of recordable events for a given director, and (iv) recordable events for a given actor during a certain period of time (for example, recordable events that have been produced in the last five years and which the given actor is associated with). Other examples of series of recordable events are also possible.

### 4. CONCLUSION

The use of a system or a method of intelligent indexing of recordable events provides means for improving the user experience of the system. In particular, the use of intelligent indexing of recordable events in a digital video recording system improves the user experience by enabling the user to find recordable events based on various forms of data for a given piece of data associated with the recordable events. Improving the user experience increases the likelihood that the user takes advantage of features available in the system and increases the likelihood that the user will not return the system due to user dissatisfaction.

An exemplary embodiment of the present invention has been described above. Those skilled in the art will understand, however, that changes and modifications may be made to the embodiment described without departing from the true scope and spirit of the present invention, which is defined by the claims.

1. A method for indexing a recordable event identifier, wherein the method comprises:
storing a first form of the recordable event identifier into a first portion of a recordable event identifier index; and
storing a second form of the recordable event identifier into a second portion of the recordable event identifier index.

2. The method as recited in claim 1, wherein the first form of the recordable event identifier is arranged as a family name followed by a given name, and wherein the second form of the recordable event identifier is arranged as the given name followed by the family name.

3. The method as recited in claim 1, wherein the first form of the recordable event identifier is arranged as an identifier prefix followed by an identifier body, and wherein the second form of the recordable event identifier is arranged as the identifier body followed by the identifier prefix.

4. The method of claim 3, wherein the identifier prefix is selected from the group consisting of the, a, and an.

5. The method as recited in claim 1, wherein the first form of the recordable event identifier is arranged as a correctly spelled identifier, and wherein the second form of the recordable event identifier is arranged as an often incorrectly spelled identifier.

6. The method as recited in claim 1, further comprising:
receiving a set of recordable event identifier data that includes the recordable event identifier in the first form and the recordable event identifier in the second form, wherein the set of recordable event identifier data includes a plurality of other recordable event identifiers.

7. The method as recited in claim 1, further comprising:
receiving a set of recordable event identifier data that includes the recordable event identifier in the first form of the recordable event identifier; and
analyzing the recordable event identifier to determine that the second form of the recordable event identifier should be formed, and responsively forming the second form of the recordable event identifier.

8. The method as recited in claim 1, further comprising:
entering a character string of the recordable event identifier for locating the recordable event identifier within the recordable event identifier index; and
analyzing the character string to determine whether the first portion of the recordable event identifier index or the second portion of the recordable event identifier index is an appropriate index for storing the character string, and responsively searching for the character string within the appropriate index for storing the character string.

9. The method as recited in claim 8, wherein entering the character string of the recordable event identifier involves:
entering a number of characters less than a total number of characters of the character string that matches the recordable event identifier in either the first form of the recordable event identifier or the second form of the recordable event identifier;
searching the recordable event identifier index to locate the recordable event identifier after entering the number of characters less than the total number of characters, and responsively displaying the recordable event identifier so that a user may then select the recordable event identifier without having to enter the total number of characters of the character string.

10. A system for indexing a recordable event identifier, wherein the system comprises:
a communication interface for receiving a recordable event identifier, wherein the recordable event identifier is arranged as a first form of the recordable event identifier;
a processor communicatively coupled to the communication interface and for executing a set of program instructions; and
data storage communicatively coupled to the processor, and for storing a recordable event identifier index and the set of program instructions, wherein the set of program instructions include instructions for (i) analyzing the recordable event identifier to produce a second form of the recordable event identifier, and (ii) storing the first form of the recordable event identifier and the second form of the recordable event identifier in the recordable event identifier index.

11. The system of claim 11, further comprising a user interface for entering a character string to be searched for within the recordable event identifier index, wherein the set of program instructions further include instructions for analyzing the character string and for searching an appropriate part of the recordable event identifier index that would store a recordable event identifier that matches the character string, and wherein the user interface is communicatively coupled to the processor.
